(19) United States
(12) Patent Application Publication
(10) Pub. No.: US 2022/0057264 A1
(43) Pub. Date: Feb. 24, 2022

(54) METHOD FOR CALIBRATING A SPECTROMETER

(71) Applicant: Endress+Hauser Conducta GmbH+Co. KG, Gerlingen (DE)

(72) Inventors: Joachim Bolle, Stockach (DE); Thilo Krätschmer, Gerlingen (DE); Frank Weber, Stuttgart (DE); Julian Oser, Stuttgart (DE)

(21) Appl. No.: 17/416,904

(22) PCT Filed: Nov. 21, 2019
(86) PCT No.: PCT/EP2019/082024

§ 371 Date: Jun. 21, 2021

(30) Foreign Application Priority Data
Dec. 20, 2018 (DE) 10 2018 133 152.5

(51) Int. Cl. G01J 3/02; G01J 3/28

(52) U.S. Cl. CPC G01J 3/0297; G01J 3/28

(57) ABSTRACT

The present disclosure discloses a method for calibrating a spectrometer, comprising the steps of: transmitting light by means of a light source, wherein the light source has a known and substantially temporally steady emission spectrum; receiving the light as a receiving spectrum; comparing the receiving spectrum to the emission spectrum and determining a deviation; and taking into account the determined deviation during subsequent measurements using the spectrometer, if the deviation is greater than a tolerance value.

The invention relates to a method for calibrating a spectrometer, a measuring system comprising a spectrometer, a computer program, and a computer-readable medium.

The problem underlying the invention will be described on the basis of the optical spectroscopy in process automation. Spectrometers have a wavelength calibration from the factory. This is defined, for example, by a third-degree polynomial. The wavelength calibration assigns the individual pixels of a detector to a specific wavelength.

To provide this assignment, each spectrometer must be calibrated after its fabrication. For this purpose, the spectrometer is connected to a defined calibration light source. After the calibration light source has been connected to the spectrometer, a routine is started which maps the emission spectrum of the calibration light source onto the pixels. In the sample case, a 3rd-degree polynomial is then calculated which conforms to the predetermined peaks.

A spectrometer is usually installed in a measuring system, which comprises further components such as a data processing unit, a defined access to the measuring medium, etc.

During the lifetime of a spectrometer, changes to the spectrometer can occur due to mechanical, thermal, aging-related, or other stresses. As a result, the wavelengths are no longer deflected onto their originally calibrated pixels of the detector, but onto an adjacent pixel. Depending upon the temperature change, this effect can also involve several pixels. This change can lead to a misinterpretation of the wavelength. As a result, it may be necessary to repeat the wavelength calibration. For this purpose, it is necessary to remove the measuring system from the process, clean it, and, if necessary, dismantle it. Dismantling a measuring system can sometimes prove difficult, since optical components may be glued. This is very time-consuming and costly.

The calibration light source necessary for calibration is generally designed only as a laboratory light source. Thus, the spectrometer has to be returned to either the manufacturer or a service partner, which entails great effort, concomitant high costs, and a measurement site that is not functional for a longer period of time. As an alternative, the operator can buy or borrow a calibration light source and, if necessary, be trained in performing a calibration. This variant is also complicated and cost-intensive.

The aim of the invention is to propose a simplification of the calibration of a spectrometer.

The aim is achieved by a method comprising the steps of: transmitting light by means of a light source, wherein the light source has a known and substantially temporally steady emission spectrum, receiving the light as a receiving spectrum, comparing the receiving spectrum to the emission spectrum and determining a deviation, and taking into account the determined deviation during subsequent measurements using the spectrometer, if the deviation is greater than a tolerance value.

This results in a wavelength calibration in measuring systems with a spectrometer by using a light source installed in the measuring system, without dismantling the spectrometer itself.

In this case, the light is transmitted from the light source in the direction of the medium to be measured, the measuring medium.

One embodiment provides that the method further comprise the step of: performing an adjustment, if the determined deviation is greater than the tolerance value.

One embodiment provides that the emission spectrum of the light source be temperature-independent. The light source thus emits the same emission spectrum at each temperature.

In one embodiment, the emission spectrum of the light source depends upon the temperature. In this case, a temperature measurement of the light source is first performed, and the emission spectrum at the corresponding temperature is used.

One embodiment provides that the emission spectrum of the light source be temperature-stable with respect to the process. The emission spectrum of the light source need only be temperature-stable with respect to the process. Thus, if the temperature of the process, i.e., the medium to be measured, does not change, it does not matter if the emission spectrum of the light source is fundamentally temperature-dependent, since only a constant temperature is relevant. In other words, the temperature of the light source is decisive and must be constant for this embodiment. However, the temperature of the light source may change in the case of, for example, a varying ambient temperature or during warm-up of the probe. The temperature of the light source must then be determined, and the possibly temperature-dependent emission spectrum of the light source must be known.

In one embodiment, the comparison of the receiving spectrum to the emission spectrum is performed on the basis of a characteristic feature of the receiving spectrum. In general, it must be possible to deduce one or more wavelengths from the shape of the emission spectrum. The claimed method thus functions with all light sources whose emission spectrum is not spectrally constant over the emission range.

One embodiment provides that the comparison of the receiving spectrum to the emission spectrum be performed on the basis of a single peak. This is possible especially if all peaks shift in the same way, i.e., for example, all have a positive offset.

One embodiment provides that the emission spectrum comprise at least two, especially at least three, peaks, and the comparison of the receiving spectrum to the emission spectrum be performed on the basis of the peaks. In one embodiment, one peak is in the lower frequency range and one peak is in the upper frequency range of the emission spectrum. Especially, a third peak is in the middle frequency range of the emission spectrum.

In one embodiment, the peak or peaks is configured as a dip (peak downwards), jump, discontinuous point, extreme point, high point, low point, or point of inflection in the emission spectrum. One embodiment provides that the course of the emission spectrum per se be used. In one embodiment, the course of the emission spectrum per se is used in a specific wavelength range.

One embodiment provides that the light be transmitted through a defined test medium in order to calibrate the spectrometer.

In principle, the defined test medium can be freely selected. It is important only that the same always be used and that this provide the same repeatable results.

One embodiment provides that the test medium be air or nitrogen.

One embodiment provides that the test medium be the measuring medium. This is especially the case when the measuring medium does not act as a filter for the light emitted by the light source, especially not in the wavelength range of the peak or peaks.

One embodiment provides that taking into account the determined deviation include a temperature compensation. If, in the measurement system, a light source with a known emission spectrum is used and has characteristic emission peaks, this can be used for temperature compensation. The wavelength shift caused by the temperature is thus compensated for.

One embodiment provides that taking into account the determined deviation include the aging of the measuring system. One embodiment provides that taking into account the determined deviation include mechanical stress.

The aim is further achieved by a measuring system comprising at least one light source, a spectrometer, the spectrometer especially comprising at least one mirror, grating, a receiver, especially a CCD sensor, and entrance slit, and a data processing unit which is designed to carry out the steps of the method as described above.

One embodiment provides that the measuring system comprise a temperature sensor.

One embodiment provides for the light source to be configured as a xenon flash lamp, gas-discharge lamp, incandescent lamp, or fluorescent lamp.

One embodiment provides for the light source to be configured as an LED. In general, the light source is configured as a temperature-dependent light source. In this case, the temperature-dependent emission spectrum of the light source must be known and taken into account when comparing the receiving spectrum to the emission spectrum and determining the deviation.

The aim is further achieved by a computer program comprising instructions which cause the measuring system as described above to carry out the method steps as described above.

The aim is further achieved by a computer-readable medium on which the computer program as described above is stored.

One embodiment provides that the emission spectrum of the light source be stored on the medium.

This is explained in more detail with reference to the following figures.

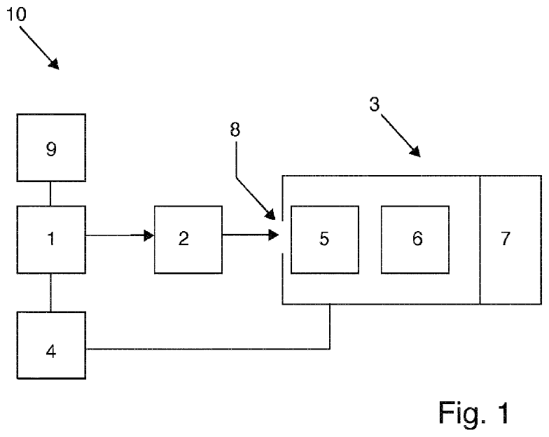

FIG. 1 shows the claimed measuring system.

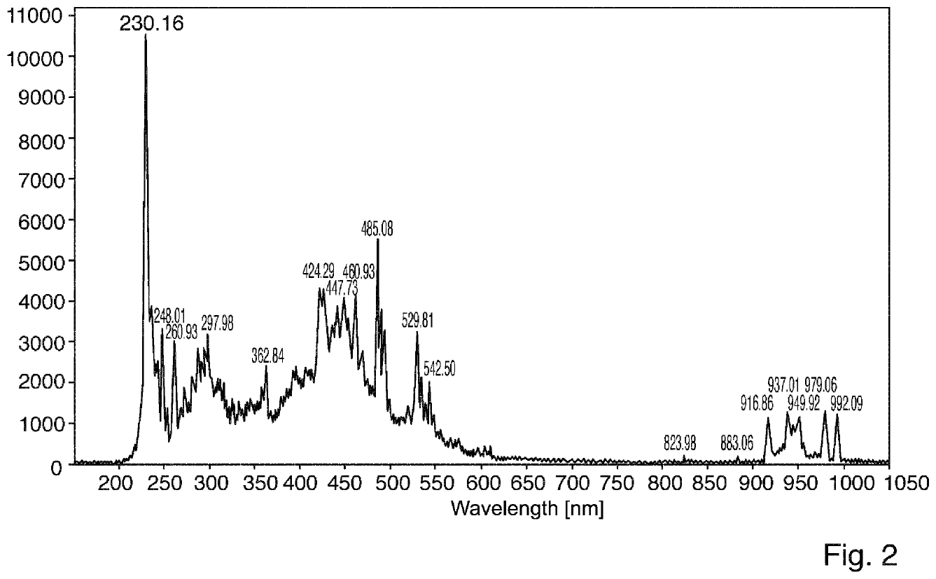

FIG. 2 shows an emission spectrum of a xenon flash lamp.

The claimed measuring system in its entirety is denoted by reference sign 10 and is shown in FIG. 1.

The measuring system 10 comprises at least one light source 1, a spectrometer 3, and a data processing unit 4 which is designed to carry out the steps of the claimed method, i.e., for example, to switch the light source 1 on and off or to perform the data processing.

The spectrometer 3 is shown only symbolically in FIG. 1 and comprises at least a mirror 5, grating 6, and a receiver 7. Mirror 5 and grating 6 can be configured as a single component. The receiver is configured as a CCD sensor. At the entrance of the spectrometer 3 is an entrance slit 8.

Light from the light source 1, which is configured, for example, as a xenon flash lamp, is transmitted from the light source 1 in the direction of the measuring medium 2. The measuring medium 2 can be the medium actually to be measured. During the method for calibrating the spectrometer 3, the measuring medium 2 can be replaced by a test medium such as air, nitrogen, or, optionally, also a vacuum. The light source 1 can also be designed as an LED. If the emission spectrum of the light source 1 is temperature-dependent, the measuring system 10 comprises a temperature sensor 9 which is arranged at, in, or at least in the vicinity of the light source 1.

A transmission measurement is shown. For this purpose, the light source 1 comprises one or more windows which are at least partially transparent to the emitted light. The measuring medium 2 is separated from the optical and electronic components of the measuring system 10 by the windows.

If, in the measurement system 10, a light source 1 with a known emission spectrum is used and has one or more characteristic emission peaks, this can be used for wavelength calibration. For this purpose, it need only be ensured that the measuring system 10 is located in a medium (liquid, gas, solid, etc.) whose absorption spectrum allows the determination of the characteristic emission peaks of the lamp. This includes, on the one hand, that no excessive absorption takes place through the medium, so that sufficient light is still present for detecting the emission peaks. On the other hand, no absorptions should occur which prevent an unambiguous identification of the emission peaks of the light source 1. In order to calibrate the wavelength, it is not absolutely necessary for the measuring system 10 to be perfectly cleaned, since the intensity in this case plays no role for the calibration. For example, the emission spectrum of a xenon flash lamp (see FIG. 2) can be used for wavelength calibration.

In addition to the use of one or more characteristic emission peaks, a dip (peak downwards), jump, discontinuous point, extreme point, high point, low point, or point of inflection in the emission spectrum can also be used. The course of the emission spectrum, e.g., in a specific wavelength range, can also be used.

Calibration is possible in-line, without great maintenance effort. It need merely be ensured by the user that the spectrometer 3 is located in a defined medium. A “defined medium” in this context is to be understood as a medium in which a characterization of the emission spectrum, i.e., the assignment of at least one wavelength to a characteristic feature (extreme value, point of inflection, peak, dip, jump, etc.), is possible. In the wavelength range of this characteristic feature, the medium must not absorb all light, i.e., sufficient (detectable) light still has to arrive at the receiver 7 in this wavelength range. Furthermore, the medium must not make the characterization of the emission spectrum “unrecognizable.”

Compared to the standard method, a very large amount of time, and thereby cost, is saved. The measurement performance is also improved, since this calibration can in principle be performed as often as desired (for each measurement) without additional effort. In one embodiment, the calibration is performed before each measurement. The calibration can also be performed by non-technical personnel, since no further auxiliary means and special calibration light sources are necessary. Especially for the case in which a spectrometer with a wavelength drift over temperature is used, the measurement performance is improved.

If, in the measuring system 10, a light source 1 with a known emission spectrum is used and has characteristic emission peaks, this can also be used for temperature compensation. The wavelength shift caused by the temperature is thus compensated for. Since, for the temperature compensation of the wavelength, the absolute intensity spectrum is not of interest, but, rather, only individual pixels in the CCD sensor 7 subject to a local maximum, this compensation can take place directly in the process.

The emission spectrum of the light source 1 used at a specific temperature can be stored in the measurement system 10, e.g., in the data processing unit 4, and is compared with the emission spectrum just measured. For this purpose, characteristic emission peaks are determined, which are then used for comparison. Subsequently, the measured spectrometer is changed by means of a routine in such a way that this again coincides with the original mapping of the emission spectrum on the CCD sensor at a defined temperature (for example, room temperature). The error is reduced by temperature influences on the measurement.

Further possible compensations include aging or mechanical stress.

### LIST OF REFERENCE SIGNS

1 Light source

2 Measuring medium

3 Spectrometer

4 Data processing unit

5 Mirror

6 Grating

7 Receiver

8 Entrance slit

9 Temperature sensor

10 Measuring system

1-13. (canceled)

14. A method for calibrating a spectrometer, comprising the steps of:
transmitting light by means of a light source, wherein the light source has a known and temporally steady emission spectrum,
receiving the light as a receiving spectrum,
comparing the receiving spectrum to the emission spectrum and determining a deviation, and
taking into account the determined deviation during subsequent measurements using the spectrometer, if the deviation is greater than a tolerance value.

15. The method according to claim 14, further comprising the step of:
performing an adjustment if the determined deviation is greater than the tolerance value.

16. The method according to claim 14,
wherein the emission spectrum of the light source is temperature-stable with respect to the process.

17. The method according to claim 14,
wherein the emission spectrum of the light source is temperature-independent.

18. The method according to claim 14,
wherein the emission spectrum comprises at least two peaks, and the comparison of the receiving spectrum with the emission spectrum is performed on the basis of the peaks.

19. The method according to claim 14,
wherein the light is transmitted through a defined test medium in order to calibrate the spectrometer.

20. The method according to claim 14
wherein the test medium is air or nitrogen.

21. The method according to claim 14,
wherein taking into account the determined deviation includes a temperature compensation.

22. A measuring system,
comprising at least one light source, a spectrometer, the spectrometer comprising at least one mirror, grating a rand entrance slit, and a data processing unit which is designed to carry out the steps:
transmitting light by means of a light source, wherein the light source has a known and temporally steady emission spectrum,
receiving the light as a receiving spectrum,
comparing the receiving spectrum to the emission spectrum and determining a deviation, and
taking into account the determined deviation during subsequent measurements using the spectrometer, if the deviation is greater than a tolerance value.

23. The measuring system according to claim 22,
wherein the light source is configured as a xenon flash lamp, gas-discharge lamp, or fluorescent lamp.

24. A computer program,
comprising instructions which cause a measuring system to carry out a method; the method including:
transmitting light by means of a light source, wherein the light source has a known and temporally steady emission spectrum,
receiving the light as a receiving spectrum,
comparing the receiving spectrum to the emission spectrum and determining a deviation, and
taking into account the determined deviation during subsequent measurements using the spectrometer, if the deviation is greater than a tolerance value.

25. The computer program of claim 24, wherein the computer program is stored on a computer-readable medium.

26. The computer-readable medium of claim 15,
wherein the emission spectrum of the light source is stored on the medium.
